(19) United States
(12) Patent Application Publication
(10) Pub. No.: US 2016/0257013 A1
(43) Pub. Date: Sep. 8, 2016

(54) FOOD CUTTING DEVICE

(71) Applicant: Ontel Products Corporation, Fairfield, NJ (US)

(72) Inventor: Ross Exley, Fairfield, NJ (US)

(21) Appl. No.: 15/053,857

(22) Filed: Feb. 25, 2016

Related U.S. Application Data
(60) Provisional application No. 62/127,459, filed on Mar. 3, 2015.

(51) Int. Cl. B26D 3/11; B26D 7/06; B26D 1/03

(52) U.S. Cl. CPC B26D 3/11; B26D 1/03; B26D 7/0666

(57) ABSTRACT

The device has a crank assembly for retaining and rotating the fruit or vegetable being cut and a removeably mounted blade assembly for cutting the retained fruit or vegetable as it is rotated. A single, large diameter suction cup is attached to the bottom of the device engage the surface upon which the device is situated. A lever controls the operation of the suction cup. The crank assembly is moveable along rails to adjust the distance between the crank and blade. The rails form outwardly open channels with the top surface of the base. An inclined surface is situated beneath the blade assembly which is adapted to guide the cuttings toward the end of the base an into an adjacent bowl. The inclined surface is situated on a ramp located on the top surface of the base.

### CROSS-REFERENCE TO RELATED APPLICATIONS

Priority is claimed on Provisional Patent Application No. 62127459, filed Mar. 3, 2015, the contents of which are incorporated herein by reference.

### STATEMENT REGARDING FEDERALLY SPONSORED RESEARCH OR DEVELOPMENT

Not Applicable

### REFERENCE TO A “SEQUENCE LISTING”, A TABLE, OR A COMPUTER PROGRAM LISTING APPENDIX SUBMITTED ON COMPACT DISC

Not Applicable

### BACKGROUND OF THE INVENTION

1. Field of the Invention

The present invention relates to food cutting devices and more particularly, to a table top slicer that cuts fruits and vegetables such as zucchini, squash, carrots, cucumbers, and potatoes into spiral cuts, shoestrings, noodles and the like.

2. Description of Prior Art Including Information Disclosed Under 37 CFR 1.97 And 1.98

Table top food slicers are known. Some of the foods slicers include a base with four small suction cups located at the corners of the bottom surface of the base to retain the base on the table top during the food cutting operation. The suction cups are pushed downward toward the table top to evacuate the air in the suction cups to adhere the base to the table top. However, such suction cups are limited in the amount of force that they provide to secure the base and may dislodge if too much force is applied to the base in a direction parallel to the table top. Accordingly, a better way to stabilize the slicers during the cutting operation is needed.

Blades are commonly used as a cutting tool for slicing the fruits and vegetables. The blade must be retained in a particular position relative to the fruit or vegetable being cut as the fruit or vegetable is rotated. In particular, the blades must be situated in a plane that is substantially perpendicular to the axis about which the fruit or vegetable is being rotated.

In some table top slicers the fruit or vegetable being cut is retained by protrusions located on a rotatable plate situated on an upstanding crank mechanism. Turning the crank causes the fruit or vegetable to rotate about an axis parallel to the base. The blades are situated on an upstanding part permanently mounted to and extending from the surface of the base, which is spaced from the crank. However, such a structure is difficult to manufacture, and requires a substantial amount of space to accommodate the upstanding part during shipment and storage. Accordingly, it would be desirable to have a structure which permits the upstanding part, often referred to as a “tower,” to be removed from the base would make the slicer easier and less costly to manufacture and less space would be required to ship and store the device.

The space between the crank mechanism and the blade tower is adjustable to accommodate fruits and vegetables of different sizes. In some slicers, spaced rails on the upper surface of the base are provided to guide the movement of the crank mechanism to alter the distance between the crank mechanism and the blade tower. Each rail is formed of an upstanding part with a horizontally extending part which extends toward the other rail, which can be described as an “internal” rail. However, such internal rails are difficult to clean and tend to accumulate debris from cutting the fruit and vegetables making the movement of the crank more difficult. It would be desirable to have a structure for movement of the crank mechanism that is easier to clean and more reliable to use.

Most table top slicers have a base with a top surface which is planar. Because the area of the top surface of the base proximate the end of the base where the cuttings from the fruits and vegetables accumulate is horizontal, the cuttings pile up as the cutting operation proceeds. It would be desirable to have a structure which would facilitate the removal of the cuttings from the top surface of the base.

It is therefore a prime object of the present invention to provide a cutting device for fruits and vegetables designed to be situated on a horizontal surface such as a table top or counter top.

It is another object of the present invention to provide a cutting device for fruits and vegetables which has a removable blade tower for easy of manufacture and better shipping and storage;

It is another object of the present invention to provide a cutting device for fruits and vegetables which has external rails for guiding movement of the crank mechanism which are easy to clean and an reliable.

It is another object of the present invention to provide a cutting device for fruits and vegetables which has a base with a top surface including an inclined ramp to guide cuttings into a collection plate or bowl.

### BRIEF SUMMARY OF THE INVENTION

Those objected are achieved by the present invention which relates to a cutting device for fruits and vegetables. The device includes a base adapted to be situated on a surface such as a table top or a counter. The base has first and second sides, a top surface and a bottom surface. A crank assembly is provided for retaining and rotating the fruit or vegetable being cut. A blade is provided for cutting the retained fruit or vegetable as it is rotated. The blade is situated on an upstanding part mounted on the top surface of the base at a position spaced from the crank assembly. A single suction cup attached to the bottom surface of the base is provided for engaging the surface. The suction cup has a diameter which is slightly less than the distance between the sides of the base. A lever is provided for controlling the suction cup. The lever is moveable between a first position wherein air is drawn out of the suction cup to create a partial vacuum such that the base adheres to the surface and a second position wherein air enters the suction cup to eliminate the partial vacuum and release the base from the surface.

In accordance with another aspect of the present invention, a cutting device for fruits and vegetables is provided. The device includes a base adapted to be situated on a surface such as a table top or a counter. The base has a top surface. A crank assembly is provided for retaining and rotating the fruit or vegetable being cut. A blade is provided for cutting the retained fruit or vegetable as it is rotated. The blade is situated on an upstanding part mounted on the top surface of the base at a position spaced from the crank assembly. The upstanding part is removeably mounted on the top surface of the base.

The device also includes means for removeably mounting the upstanding part on the top surface of the base. The mounting means includes an opening in the top surface of the base and a protrusion extending from the upstanding part. The protrusion is received in the opening when the upstanding part is situated on the top surface of the base.

Means are provided for removeably engaging the protrusion to secure the upstanding part to the base. The protrusion engaging means automatically engages the protrusion as the protrusion enters the opening. It also includes a manually actuated release to disengage the protrusion.

In accordance with another aspect of the invention, a cutting device for fruits and vegetables is provided. The device includes a base adapted to be situated on a surface such as a table top or a counter. The base has a top surface including spaced, substantially parallel rails. A crank assembly is provided for retaining and rotating the fruit or vegetable being cut. A blade is provided for cutting the retained fruit or vegetable as it is rotated. The blade is situated on the base at a position spaced from the crank assembly. The crank assembly includes a crank and a member upon which the crank is mounted,. The member is moveable along the rails to adjust the distance between the crank and the blade.. The member is adapted to engage the rails. The rails include oppositely extending parts which form outwardly open channels with the top surface of the base.

The crank assembly also includes a lever moveably mounted on the member for movement between a first position wherein the member cannot move along the rails relative to the top surface of the base and a second position wherein the member can move along the rails relative to the top surface of the base to adjust the distance between the crank and the blade.

In accordance with another aspect of the present invention, a cutting device for fruits and vegetables is provided. The device includes a base adapted to be situated on a surface such as a table top or a counter. The base has an end and a top surface. A crank assembly is provided for retaining and rotating the fruit or vegetable being cut. A blade is provided for cutting the retained fruit or vegetable as it is rotated. The blade is situated proximate the base end. An inclined surface is situated beneath the blade which is adapted to guide the cuttings from the fruit or vegetable being cut toward the end of the base.

The device also includes a ramp situated on the top surface of the base. The inclined surface forms a part of the ramp.

### BRIEF DESCRIPTION OF THE SEVERAL VIEWS OF DRAWINGS

To these and to such other objects that may hereinafter appears, the present invention relates to a food cutting device as described in detail in the following specification and recited in the annexed claims, taken together with the accompanying drawings, in which like numerals refer to like parts and in which:

FIG. 1 is an isometric view showing the front, top and right side of the food cutting device;

FIG. 2 is a front elevation view of the food cutting device;

FIG. 3 is a rear elevation view of the food cutting device;

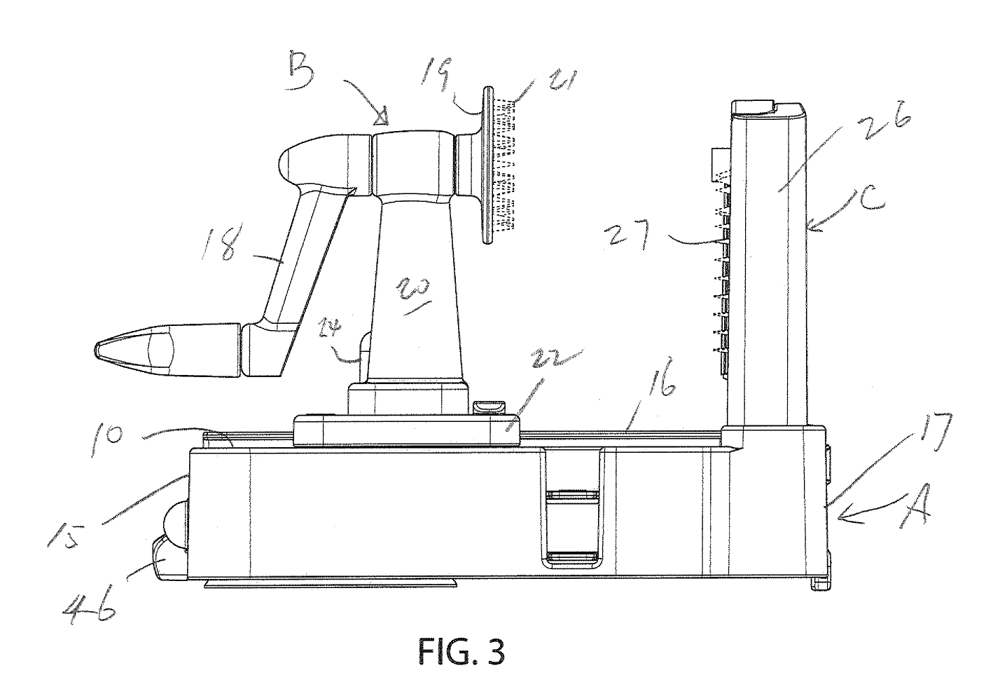

FIG. 4 is an elevation view showing the left side of the food cutting device;

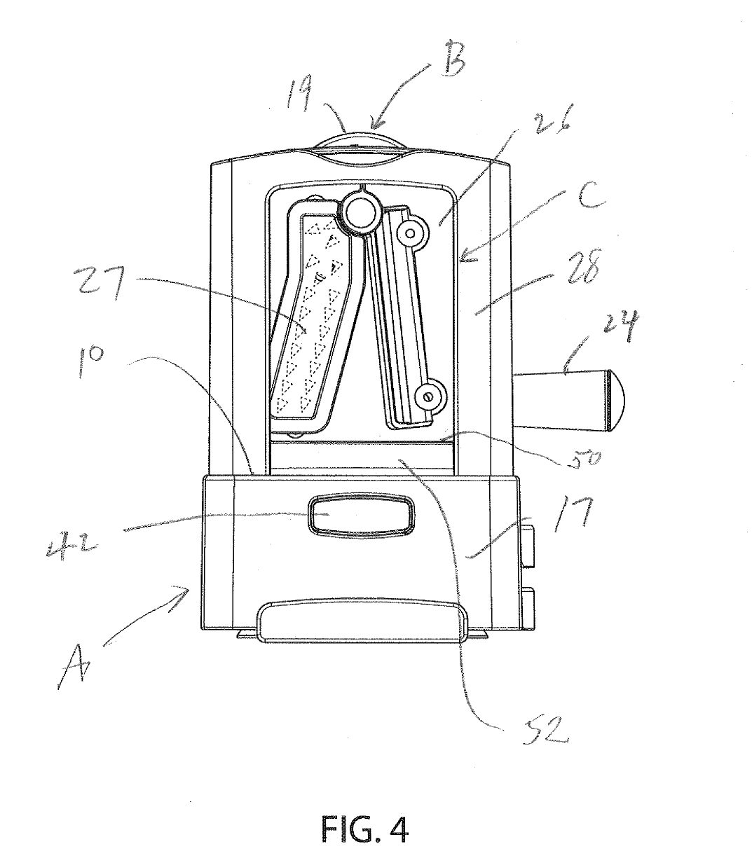

FIG. 5 is an elevation view showing the right side of the food cutting device;

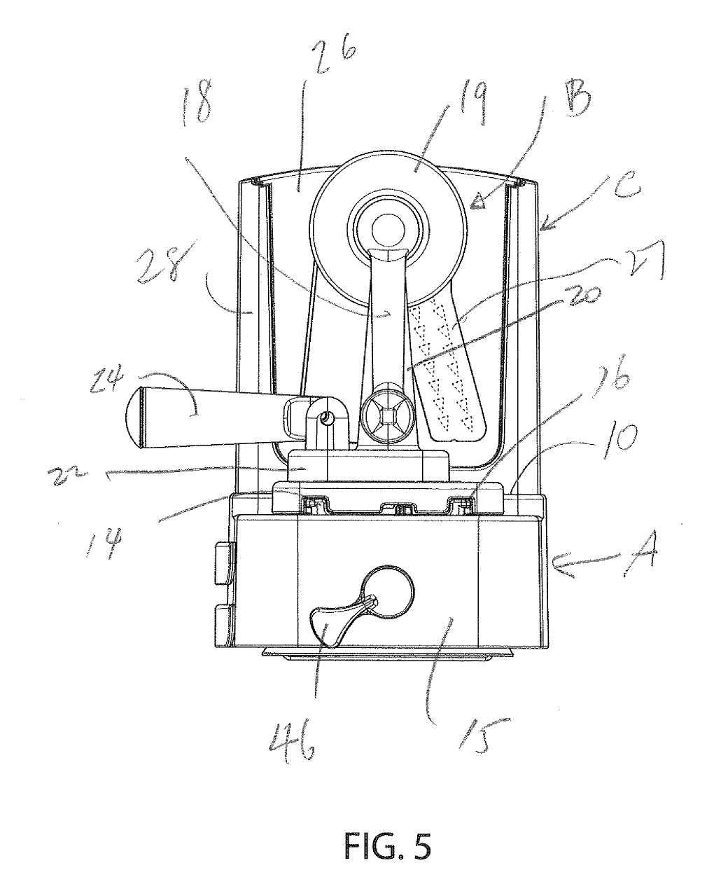

FIG. 6 is a top plan view of the food cutting device;

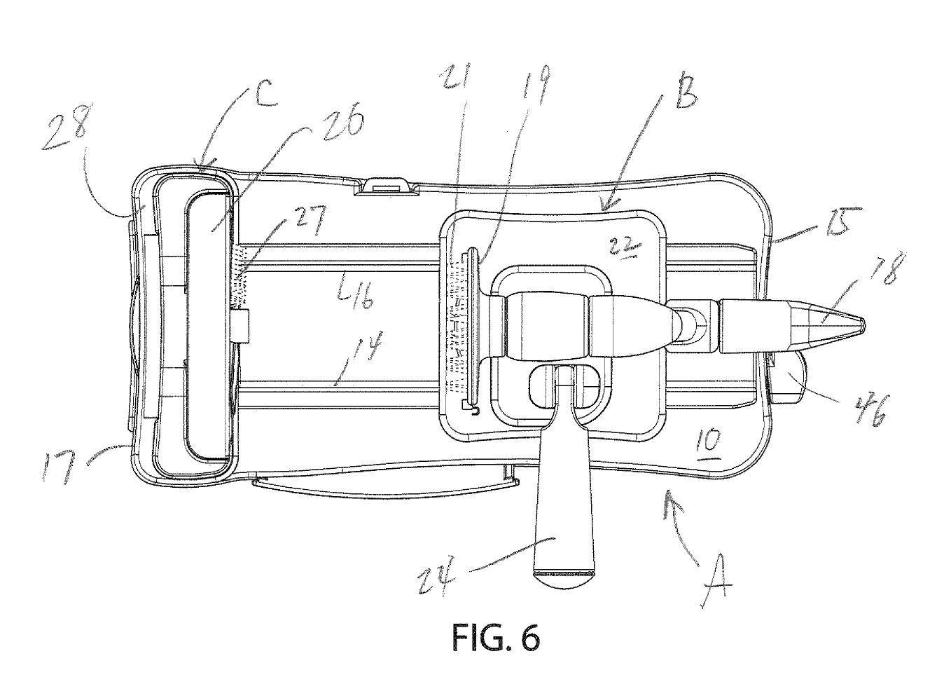

FIG. 7 is a bottom plan view of the food cutting device;

FIG. 8 is an exploded view showing the front, top and right side of the food cutting device with removable parts and interchangeable blades;

### DETAILED DESCRIPTION OF THE INVENTION

As depicted in the drawings, the present invention relates to an improved device for cutting food, in particular pasta and fruits and vegetables, such as zucchini, squash, carrots, cucumbers, and potatoes. The device is designed to be situated on a horizontal surface such as a table top or counter top.

The device includes a base, generally designated A, having a top surface 10 and a bottom surface 12. A crank assembly, generally designated B is moveably mounted on top surface 10 along spaced, substantially parallel rails 14, 16. Which extend from the front 15 of the base to a point on the top surface of the base spaced from the back end 17 of the base. The crank assembly includes a crank 18 rotatably mounted on an upstanding part 20 which in turn is situated on a member 22 which rides on rails 14, 16. Attached to the end of crank 18 is a round plate 19 which carries a plurality of protrusions 21 designed to retain the fruit or vegetable being cut.

A lever 24 is provided to clamp crank assembly B to the top surface of the base at the desired position. The lever is moveable between a horizontal position, in which the crank assembly cannot be moved along the top surface or the base, and a vertical position, wherein the crank assembly can be moved along rails 14, 16 relative to the top surface of the base.

Removeably mounted on the top surface of base B, proximate the back end 17, is a blade assembly, generally designated C. Blade assembly C includes a blade carrying cartridge 26, which includes a blade 27, and an upstanding blade “tower” 28 into which cartridge 26 is removeably received.

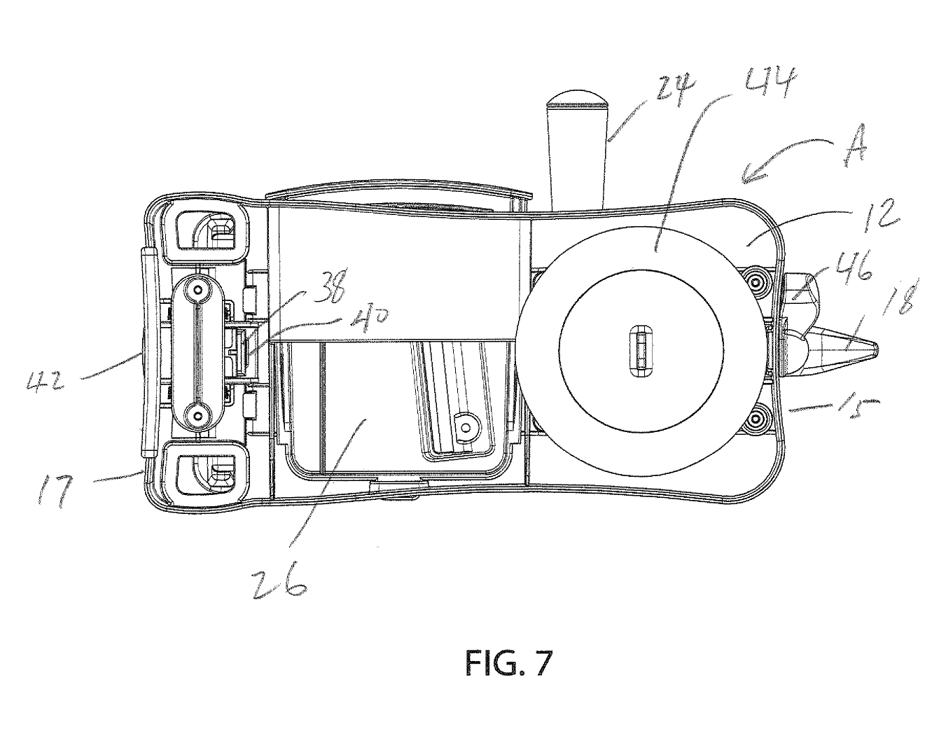

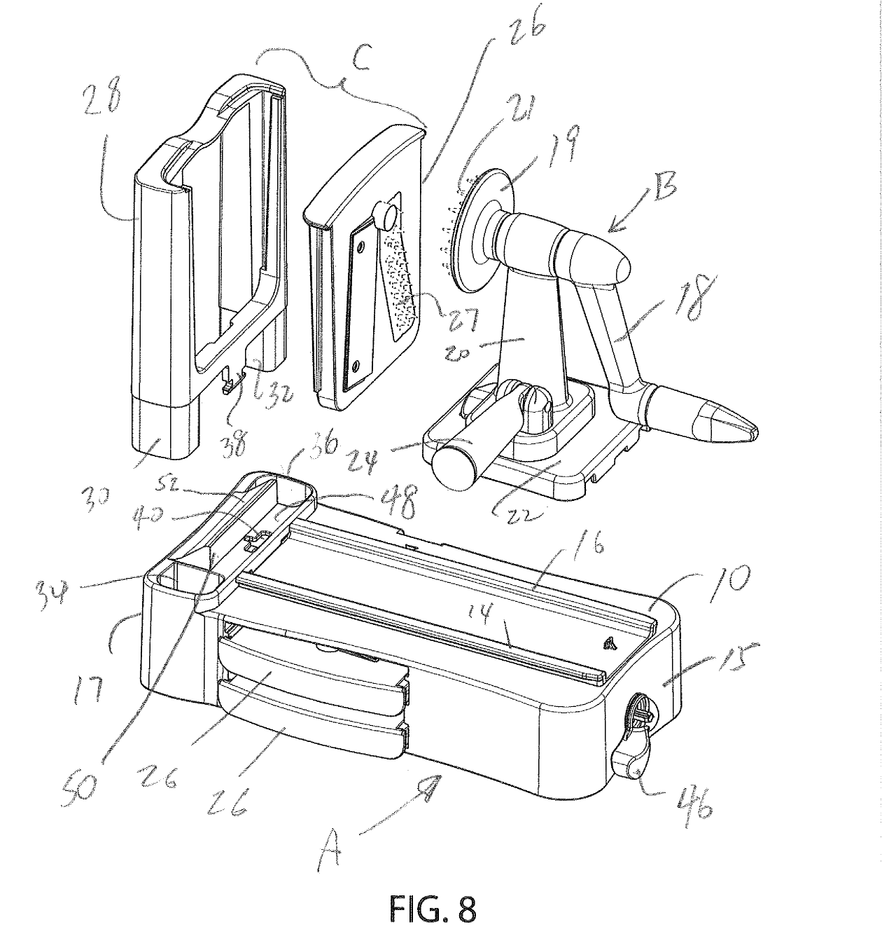

As is best seen in FIG. 8, tower 28 has spaced downwardly extending legs 30, 32 designed to be received in recesses 34, 36 in top surface 10, respectively. Between legs 30 and 32 is a “T” shaped protrusion 38. Protrusion 38 is adapted to be received in opening 40 is top surface 10 in a “snap-fit” manner. A bayonet type connection, not shown) could also be used. Below surface 10 is a flexible part with an inclined surface which is cammed out of the way as protrusion 38 enters opening 40 and when the protrusion reaches the desired depth, springs back to its original position to engage the enlarged end of protrusion 38. Protrusion 38 will remain engaged until button 42 on the back 17 of the base is depressed, see FIG. 7.

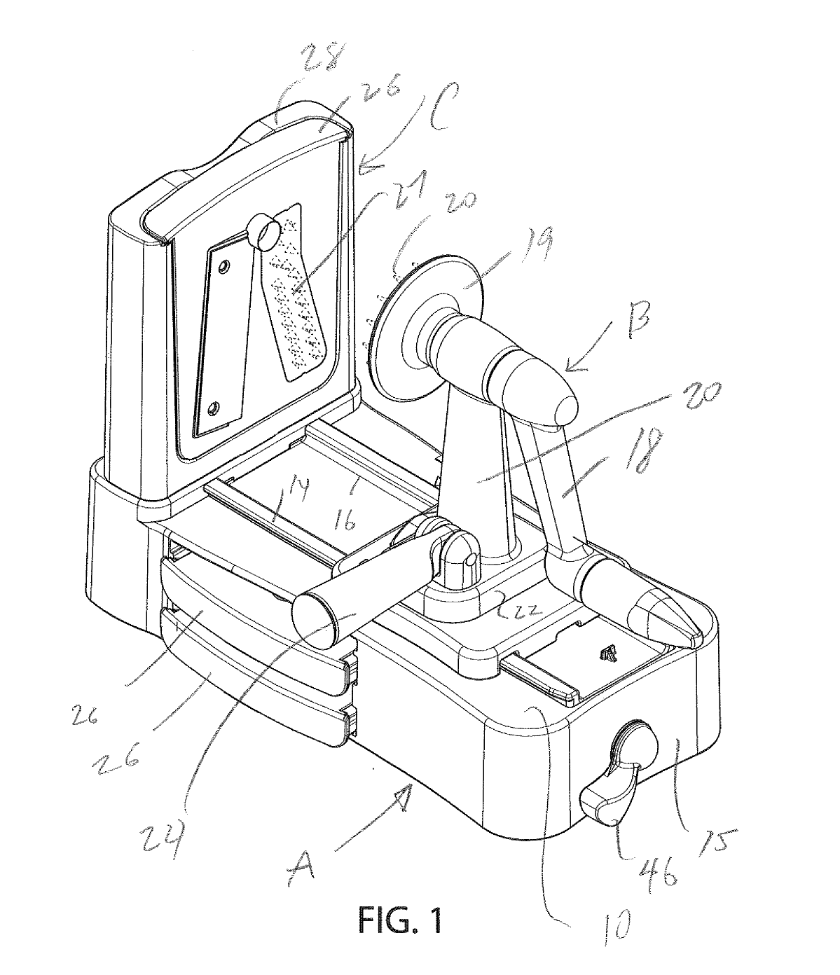

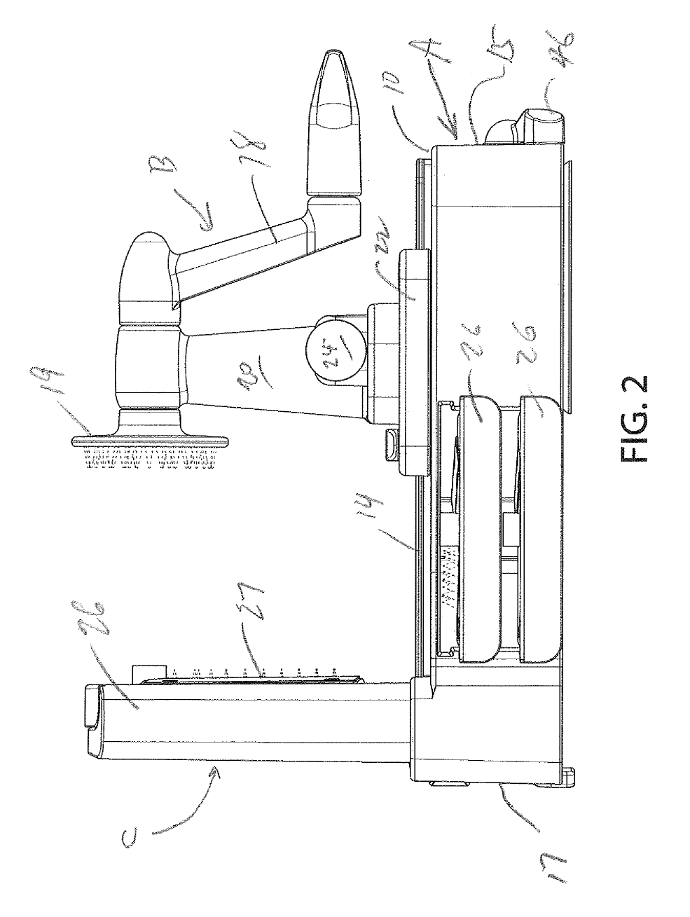

This feature creates two advantages: 1) a manufacturing advantage, in that it makes for more simple injection mold design; and 2) a storage advantage for the end user, in that the knock-down item and its parts can be stored easily and compactly in a drawer, within the base, as best seen in FIGS. 1, 2 and 8 such that the blade are interchangeable.

The device includes a single large suction cup 44 with a diameter almost as large as the distance between the sides of the base. A lever 46 mounted on the front 15 of the base operates the suction cup. Lever 46 can be rotated between a first position, wherein the suction cup is connect to the environment such that it that air can enter, towards a second position wherein a partial vacuum is created to cause the base to be secured to a surface. Using a large controllable suction cup in this manner provides as much suction power as multiple suction cups. This feature accommodates the heavy forces of spiral cutting and makes it significantly easier to release the suction. It is a one step process, as opposed to a multiple step process of releasing multiple suctions cups individually, which are found in each “corner” or spread out along the bottom of the conventional slicers.

The device employs rails 14 and 16 which have outwardly open slide channels along which crank assembly B can travel in order to adjust the distance between crank assembly B and blade assembly C. Outwardly open slide channels make the device much easier to clean and are significantly more reliable for the sliding action than internal channels employed by other cutting devices.

However, the rails 14, 16 do not extend into the cutting area 48 below blade assembly C, as best seen in FIG. 8. This creates two advantages; 1) it allows the device to be much smaller; and 2) does not require the cut food to be “pushed” through the exiting slide at the back end of the base. Instead, within the cutting are is a ramp 50 which includes an inclined surface 52. Food that is cut with the device simply “falls” onto a plate or bowl situated adjacent to the back end of the base by means of inclined surface 52 of ramp 50.

While only a single preferred embodiment of the present invention has been disclosed for purposes of illustration, it is obvious that many modifications and variations could be made thereto. It is intended to cover all of those modifications and variations which fall within the scope of the present invention, as defined by the following claims.

I claim:

1. A cutting device for fruits and vegetables comprising a base adapted to be situated on a surface such as a table top or a counter, said base having a first and second sides, a top surface and a bottom surface, a crank assembly for retaining and rotating the fruit or vegetable being cut and a blade for cutting the retained fruit or vegetable as it is rotated, said blade being situated on an upstanding part mounted on said top surface of said base at a position spaced from said crank assembly, a single suction cup attached to said bottom surface of said base for engaging the surface, said suction cup having a diameter which is slightly less than the distance between said sides of said base, and a lever for controlling said suction cup, said lever being moveable between a first position wherein air is drawn out of said suction cup to create a partial vacuum such that said base adheres to the surface and a second position wherein air enters the suction cup to eliminate the partial vacuum and release said base from the surface.

2. A cutting device for fruits and vegetables comprising a base adapted to be situated on a surface such as a table top or a counter, said base having a top surface, a crank assembly for retaining and rotating the fruit or vegetable being cut and a blade for cutting the retained fruit or vegetable as it is rotated, said blade being situated on an upstanding part mounted on said top surface of said base at a position spaced from said crank assembly, said upstanding part being removeably mounted on said top surface of said base.

3. The device of claim 2 further comprising means for removeably mounting said upstanding part on said top surface of said base.

4. The device of claim 3 wherein said mounting means comprises an opening in said top surface of said base and a protrusion extending from said upstanding part, said protrusion being received in said opening when said upstanding part is situated on said top surface of said base, and means for removeably engaging said protrusion to secure said upstanding part to said base.

5. The device of claim 4 wherein said protrusion engaging means automatically engages said protrusion as the protrusion enters said opening and further comprises a manually actuated release to disengage said protrusion.

6. A cutting device for fruits and vegetables comprising a base adapted to be situated on a surface such as a table top or a counter, said base having a top surface including spaced, substantially parallel rails, a crank assembly for retaining and rotating the fruit or vegetable being cut, a blade for cutting the retained fruit or vegetable as it is rotated, said blade being situated on said base at a position spaced from said crank assembly, said crank assembly comprising a crank and a member upon which said crank is mounted, said member being moveable along said rails to adjust the distance between said crank and said blade, said member being adapted to engage said rails, wherein said rails comprise oppositely extending parts which form outwardly open channels with said top surface of said base.

7. The device of claim 6 wherein said crank assembly further comprises a lever moveably mounted on said member for movement between a first position wherein said member cannot move along said rails relative to said top surface of said base and a second position wherein said member can move along said rails relative to said top surface of said base to adjust the distance between said crank and said blade.

8. A cutting device for fruits and vegetables comprising a base adapted to be situated on a surface such as a table top or a counter, said base having an end and a top surface, a crank assembly for retaining and rotating the fruit or vegetable being cut, a blade for cutting the retained fruit or vegetable as it is rotated, said blade being situated proximate said base end and an inclined surface beneath said blade adapted to guide the cuttings from the fruit or vegetable being cut toward said base end.

9. The device of claim 8 further comprising a ramp situated on said top surface of said base.

10. The device of claim 9 wherein said inclined surface forms a part of said ramp.
